(19) United States
(12) Patent Application Publication
(10) Pub. No.: US 2006/0228003 A1
(43) Pub. Date: Oct. 12, 2006

(54) Method and apparatus for detection of optical elements

(76) Inventor: D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/099,833

(22) Filed: Apr. 6, 2005

(51) Int. Cl. G06K 9/00

(52) U.S. Cl. 382/115

(57) ABSTRACT

A method and apparatus for detection of optical elements. The apparatus includes an illumination unit for projecting light into a target area to illuminate the target area, and an image capture unit for capturing images of the target area in an illuminated condition and a non-illuminated condition. An image comparison unit compares images of the target area in an illuminated condition and a non-illuminated condition to detect Fresnel reflections of light from the illumination unit.

### BACKGROUND OF THE INVENTION

The ability to detect optical elements (e.g., eyes, eyeglasses, camera lenses, binoculars, rifle scopes, telescopes, and so on) from a distance would be useful for many diverse applications. In digital photography, for example, detecting the eyes of human and animal subjects could be used for purposes such as concentrating image enhancement processing on the face of the subject. Similarly, detecting eyeglasses on a subject would be helpful when ascertaining the need for image processing to reduce glare from the eyeglasses. In security applications, the ability to detect optical elements could be used to identify camera lenses, binoculars, telescopes, and so on, that may be conducting surveillance of a subject. In the motion picture industry, the ability to detect camera lenses in a theater could be used prevent illicit recording of movies. In military or law enforcement applications, rifle scopes could be detected to pinpoint the location of snipers. Many other varied and practical applications can be imagined.

### SUMMARY

The invention described herein provides a method and apparatus for detection of optical elements. In one embodiment, an optical element detection apparatus comprises an illumination unit for projecting light into a target area to illuminate the target area, and an image capture unit for capturing images of the target area in an illuminated condition and a non-illuminated condition. An image comparison unit compares images of the target area in an illuminated condition and a non-illuminated condition to detect Fresnel reflections of light from the illumination unit.

### BRIEF DESCRIPTION OF THE DRAWINGS

FIG. 1 is a block diagram of one embodiment of a detection apparatus according to the invention.

FIG. 2A is a flow chart illustrating one embodiment of a detection method according to the invention.

FIG. 2B is a flow chart illustrating another embodiment of a detection method according to the invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

The formation of Fresnel reflections is well-understood by those skilled in the art, and is too lengthy for full description here. However, a brief description is in order.

In the field of optics, it is known that as a beam of light passes through an optical element such as a lens, a portion of the incident light is reflected at every interface at which there is a discontinuity in the refractive index of the light transmitting medium. In particular, reflections typically occur at the surfaces of optical elements, such as each time the light enters and exits the optical element. The images formed by the reflected light are generally referred to as Fresnel images or Fresnel reflections. The images formed by the reflected light may be real or virtual images of the light source, depending upon the particular shapes and arrangements of the optical elements.

Optical elements, as found in eyes, eyeglasses, camera lenses, binoculars, rifle scopes, telescopes, and so on, have the somewhat unique property of having large and nearly perfect spherical reflective surfaces. When a beam of light hits a spherical reflective surface, either concave or convex, a real or virtual point image of the beam of light is formed. When viewed from the source of the beam of light, the point image of the beam of light appears as a sharp point of light. In an optical system with multiple optical elements, reflections from each optical surface will form a plurality of point images. Reflective spherical surfaces other than a series of optical elements, such as a mirror, will form only a single point image of the light source. If an object forms a plurality of point images of the light source, the object is almost certainly a series of optical elements forming a lens system of some type.

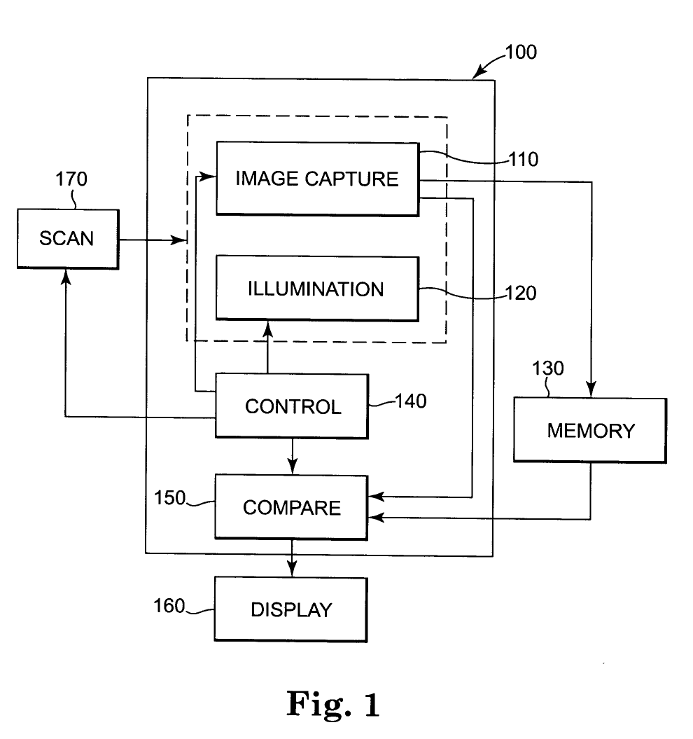

FIG. 1 is a block diagram of one exemplary embodiment of an apparatus 100 for detection of optical elements according to the invention. The exemplary detection apparatus 100 includes an image capture unit 110 and an associated illumination unit 120. In one embodiment, the image capture unit 110 is a digital imaging device selected from any such devices as are known in the art. Exemplary digital imaging devices include CCD and CMOS imaging devices, as are commonly used for image sensing in modem digital cameras. In one embodiment, the apparatus 100 of FIG. 1 is a digital camera, and includes a lens or lens system for focusing an image on the image capture unit 110. In one embodiment, one or more of a series of images captured by image capture unit 110 are stored at least temporarily in memory 130. In one embodiment, memory 130 is an external memory device. In another embodiment, memory 130 is internal to the detection apparatus 100.

The illumination unit 120 associated with the image capture unit 110 is configured to selectively project light into a target area (not shown) and thereby illuminate the target area. In one embodiment, the illumination unit 120 projects an enlarged beam of coherent light in generally parallel alignment with the optical axis of any lens or lens system used in conjunction with the image capture unit 110. In another embodiment, the illumination unit 120 projects the beam of light in substantially coaxial alignment with the optical axis of the lens or lens system used with the image capture unit 110. In one embodiment, the illumination unit 120 is a laser providing a beam of collimated light. In another embodiment, the illumination unit 120 is point-source of light configured to produce a substantially planar wave-front of light. In one implementation, the point source of light is, for example, a strobe flash on a camera. In one embodiment, the illumination unit emits light in a spectrum that is visible to the human eye. In another embodiment, the illumination unit emits light in a spectrum that is invisible to the human eye, for example, in the infrared spectrum.

A control unit 140 controls and synchronizes the operation of image capture unit 110 and illumination unit 120, such that image capture unit 110 captures images of the target area when the target area is illuminated by illumination unit 120 (an ‘illuminated image”), and also when the target area is not illuminated by the illumination unit 120 (a “non-illuminated image”). The illuminated and a non-illuminated images of the target area are captured closely in time to minimize differences in composition between the illuminated and non-illuminated images. The length of time between the capturing of illuminated and non-illuminated images of the target area will depend upon how rapidly elements in the target area are changing. For example, if the target area is in a movie theater, the patrons move relatively little, and the time between capturing the illuminated and non-illuminated images may be relatively long (on the order of several seconds). On the other hand, if the target area is a city street, pedestrians and automobiles move quickly, and the time between capturing the illuminated and non-illuminated images may be relatively short (on the order of a second or less).

The control unit 140 causes an image comparison unit 150 to compare illuminated and non-illuminated images of the target area and identify differences between the images. In one embodiment, the image comparison unit 150 compares previously captured images retrieved from memory 130. In another embodiment, the image comparison unit compares a previously captured image retrieved from memory 130 with a real-time image from the image capture unit 110. If captured closely in time, or if the target area is changing slowing over time, as described above, the illuminated and non-illuminated images should be substantially identical (i.e., no or minimal differences between the illuminated and non-illuminated images), except the illuminated image will also include Fresnel reflections of light from the illumination unit 120 if there are any optical elements in the target area. As described above, the Fresnel reflections will appear as point images of the light from the illumination unit 120. In one embodiment, the location of detected Fresnel reflections are shown on display 160. In one embodiment, display 160 is an external to detection apparatus 100, such as a video monitor connected to apparatus 100. In another embodiment, display device is integral to detection apparatus 100. In one embodiment, the image comparison unit 150 creates a difference image from the compared images, where the difference image includes only Fresnel reflections.

In some applications, the target area illuminated by the illumination unit 120 may not be large enough to encompass the entire area of interest. For example, in a movie theater, the illumination unit 120 may project a beam of light that illuminates only a portion of the seats in the theater, but it is desired to look for optical elements in all of the theater seats. In some embodiments, a scanning unit 170 is therefore provided for jointly and simultaneously scanning image capture unit 110 and the illumination unit 120 across a plurality of target areas. The scanning unit 170 may comprise any known means for simultaneously directing the image capture unit 110 and light from the illumination unit 120 across an area larger than a single target area. In one embodiment, scanning unit 170 is a mechanical scanning means, such as a drive motor that physically rotates the image capture unit 110 and illumination unit 120, or a movable mirror that redirects the projected light and reflections thereof, while the image capture unit 110 and illumination unit 120 remain still. In one embodiment, scanning unit 170 is external to detection apparatus 100. In another embodiment, scanning unit 170 is integral with detection apparatus 100.

It should be noted that the apparatus 100 can be embodied in any electrical device including at least the elements of image capture unit 110, illumination unit 120, control unit 140, and comparison unit 150. Exemplary electrical devices include, but are not limited to, an analog or digital video camera, a personal digital assistant (PDA), a cellular telephone, or any other handheld device. It should be further noted that processing of images may or may not occur in the apparatus 100. For example, the image capture unit 110 and illumination unit 120 may be configured as a handheld unit, and the control unit 140 and comparison unit 150 may be configured in a second unit, such as in a stand-alone computer, that remotely controls the image capture and illumination units 110, 120, and the subsequent processing of captured images.

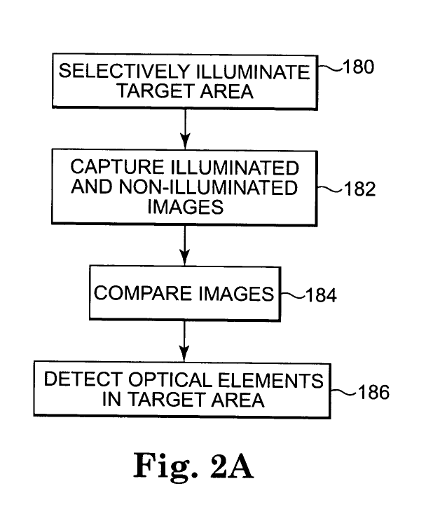

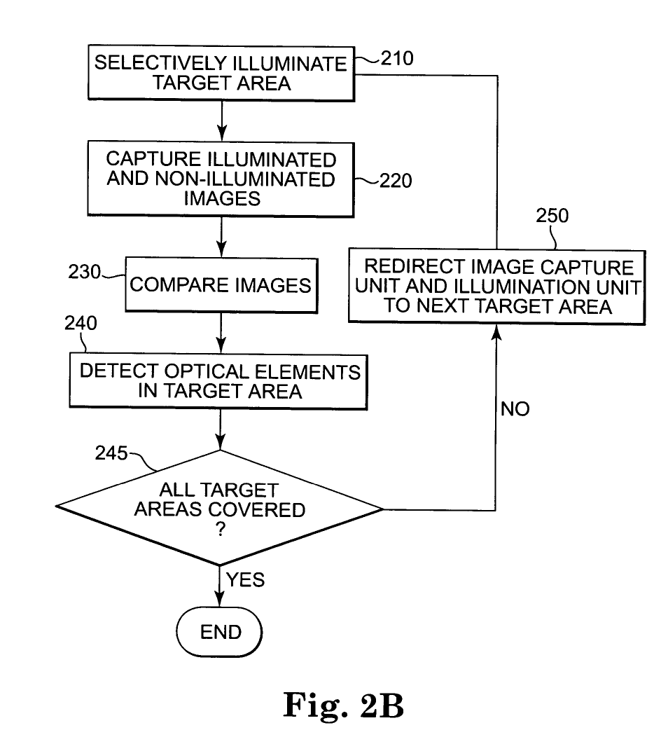

In use, the detection apparatus 100 is used to locate optical elements remote from the detection apparatus 100, and may further be used to locate optical elements that are not pointed directly at the detection apparatus. One embodiment of a method to detect optical elements according to the invention is illustrated in FIG. 2A. A target area is selectively illuminated (step 180), and illuminated and non-illuminated images of the target area are captured (step 182). The illuminated and non-illuminated images are compared (step 184), and optical elements in the target area are identified by the presence of Fresnel reflections (step 186).

Another embodiment of a method to detect optical elements according to the invention is illustrated in FIG. 2B. A target area is selectively illuminated by turning the illumination unit 120 on and off (step 210), and illuminated and non-illuminated images of the target area are captured (step 220) by the image capture unit 110. The image comparison unit 150 compares illuminated and non-illuminated images to identify Fresnel reflections of light from the illumination unit 120 (step 230). In one implementation, the comparison unit 150 identifies point images formed by Fresnel reflections by creating a difference image from the illuminated and non-illuminated images. Optical elements in the target area are detected based on the presence of point images formed by the Fresnel reflections (step 240). If more than one target area is to be examined, control unit 140 determines if all target areas have been covered (step 245). If all target areas have not been covered, the image capture unit 110 and illumination unit 120 are redirected to another target area (step 250) and the process is repeated.

In one embodiment, point images created by Fresnel reflections are analyzed to provide additional information regarding optical elements in the target area. For example, the pattern of the point images is indicative of the angular orientation of the axis of the optical elements relative to the detector. The greater the angle, the more the point images will be spaced apart. Also, the number of point images is indicative of the number of optical elements in an optical system, and may be used to discriminate different types of optical devices. For example, the presence of two sets of two closely spaced point images may be indicative of eyes in the target zone, while the presence of a single string of point images may be indicative of a camera lens, a telescope, or a rifle scope.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, optical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An optical element detection apparatus comprising:
an illumination unit for selectively projecting light into a target area to illuminate the target area;
an image capture unit for capturing images of the target area in an illuminated condition and a non-illuminated condition; and
an image comparison unit configured to compare images of the target area in an illuminated condition and a non-illuminated condition and thereby detect Fresnel reflections of light from the illumination unit.

2. The apparatus of claim 1, wherein the image comparison unit is configured to form a difference image by comparing images of the target area in an illuminated condition and a non-illuminated condition.

3. The apparatus of claim 2, wherein the difference image contains only Fresnel reflections of light from the illumination unit.

4. The apparatus of claim 1, wherein the image capture unit comprises a camera having a lens, and wherein the illumination unit projects light in parallel alignment with an optical axis of the camera lens.

5. The apparatus of claim 4, wherein the illumination unit projects light in coaxial alignment with the optical axis of the camera lens.

6. The apparatus of claim 1, wherein the image capture unit comprises a digital imaging device.

7. The apparatus of claim 6, wherein the digital imaging device is selected from the group comprising CCD and CMOS digital imaging devices.

8. The apparatus of claim 1, further comprising a scanning unit for simultaneously scanning the illumination unit and image capture unit across a plurality of target areas.

9. The apparatus of claim 8, wherein the scanning unit comprises mechanical scanning means.

10. The apparatus of claim 9, wherein the mechanical scanning means comprises a mirror.

11. The apparatus of claim 1, wherein the illumination unit comprises a laser.

12. The apparatus of claim 1, wherein the illumination unit emits in a spectrum visible to the human eye.

13. The apparatus of claim 1, wherein the illumination unit emits in a spectrum invisible to the human eye.

14. The apparatus of claim 13, wherein the illumination unit emits in the infrared spectrum.

15. The apparatus of claim 1, further comprising a memory for storing images captured by the image capture unit.

16. The apparatus of claim 1, further comprising a display unit for displaying the location of Fresnel reflections detected by the image comparison unit.

17. A method for detecting optical elements in a target area, the method comprising:
selectively illuminating the target area;
capturing illuminated and non-illuminated images of the target area;
comparing the illuminated and non-illuminated images to identify Fresnel reflections; and
detecting an optical element in the target area based on the presence of Fresnel reflections.

18. The method of claim 17, wherein selectively illuminating the target area comprises illuminating the target area with a strobe light source.

19. The method of claim 17, wherein selectively illuminating the target area comprises illuminating the target area with a laser light source.

20. The method of claim 17, wherein illuminating the target area and capturing illuminated and non-illuminated images of the target area comprises illuminating and capturing over a plurality of target areas.

21. The method of claim 20, wherein illuminating and capturing over a plurality of target areas comprises scanning with a mirror.

22. The method of claim 17, wherein illuminating the target area comprises illuminating in a spectrum visible to the human eye.

23. The method of claim 17, wherein illuminating the target area comprises illuminating in a spectrum invisible to the human eye.

24. The method of claim 23, wherein illuminating the target area comprises illuminating in the infrared spectrum.

25. The method of claim 17, wherein illuminating the target area comprises illuminating the target area with collimated light.

26. The method of claim 17, wherein capturing illuminated and non-illuminated images of the target area comprises capturing images with a photoelectric digital imaging device.

27. The method of claim 26, wherein capturing images with a photoelectric digital imaging device comprises capturing images with a photoelectric digital imaging device selected from the group comprising CCD and CMOS digital imaging devices.

28. A computer-readable medium having computer-executable instructions for performing a method for detecting optical elements in a target area, the instructions comprising:
selectively illuminating the target area;
capturing first and second images of the target area, wherein the target area is illuminated in only one of the first and second images;
comparing the first and second images to form a difference image; and
detecting an optical element in the target area based on the presence of Fresnel reflections of light in the difference image.

29. The computer-readable medium of claim 28, wherein the computer-executable instructions for performing a method for detecting optical elements in a target area further comprise illuminating and capturing images over a plurality of target areas.

30. An optical element detection apparatus comprising:
means for projecting light into a target area to illuminate the target area;
means for capturing images of the target area in an illuminated condition and a non-illuminated condition; and
means for comparing images of the target area in an illuminated condition and a non-illuminated condition and thereby detect Fresnel reflections of light from the illumination unit.
